(19) United States
(12) Patent Application Publication
(10) Pub. No.: US 2006/0169221 A1
(43) Pub. Date: Aug. 3, 2006

(54) Decorative canine cooling blanket and associated methods

(76) Inventor: Sandy A. Teague, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/050,179

(22) Filed: Feb. 3, 2005

(51) Int. Cl. A01K 13/00

(52) U.S. Cl. 119/850

(57) ABSTRACT

A decorative cooling blanket for a canine includes a textile base layer having a generally rectangular shape with a cutout head end portion to accommodate the neck of the canine. The textile base layer further includes a longitudinally extending medial portion, which is draped across the back of the canine and respective side portions that extend along the sides of the canine. The textile base layer may include a water absorbent material for cooling the canine based upon water evaporation. A border strip may cover the edges of the textile base layer. A closure strap may be connected to the textile base layer to removably secure the textile base layer on the canine. A decorative strip may be connected to an outer surface of the textile base layer and may extend between different edges thereof. A textile overlay layer may cover all or a portion of the base textile layer.

### FIELD OF THE INVENTION

The invention relates to the field of animal blankets, and, more particularly, to canine blankets and related methods.

### BACKGROUND OF THE INVENTION

Canine blankets that protect dogs exposed to harsh environments have been around for many years. For example, U.S. Pat. No. 6,584,939 to Brezinski discloses an insulating canine blanket that includes a number of straps connected to the canine blanket that are used to secure the canine blanket to the animal.

Similarly, in warmer climates, cooling canine blankets are commonly used to protect canines. A typical cooling blanket is made of a water absorbent material. The water absorbent material is saturated with water and the dog's body heat is removed as the water evaporates.

Currently, there are two main styles of cooling blankets available. The first style is made of terry cloth and has the advantage of coming in many colors. The disadvantages are that the terry cloth may be relatively inefficient at cooling, and may soil relatively quickly. The second style of cooling blanket is made of polyvinyl alcohol (PVA) fibers and has the advantages of being efficient at cooling and resistant to soiling. Mac Industries of Orlando, Fla. previously offered a PVA material canine cooling blanket under the designation Kool Koat. The Kool Koat blanket included a PVA layer, and a border strip covering its edges. Two closure straps were also provided to removably secure the blanket to the canine. The Kool Koat blanket was typically used for show dogs when at an outdoor event in warm climates. Unfortunately, the Kool Koat blanket was relatively bland in styling, perhaps especially in the eyes of proud show dog owners.

### SUMMARY OF THE INVENTION

In view of the foregoing background, it is therefore an object of the present invention to provide a canine cooling blanket that is both efficient and attractive.

This and other objects, features, and advantages in accordance with the invention are provided by a decorative cooling blanket for a canine that includes a textile base layer having a generally rectangular shape with a cutout head end portion to accommodate a neck of the canine. The textile base layer further includes a longitudinally extending medial portion, which is draped across the back of the canine, and respective side portions that extend along the sides of the canine. The textile base layer may comprise a water absorbent material for cooling the canine based upon water evaporation. A border strip may cover the edges of the textile base layer. A closure strap may be connected to the textile base layer to removably secure the textile base layer on the canine. Moreover, a decorative strip is preferably connected to an outer surface of the textile base layer and may extend between different edges thereof. Accordingly, the canine cooling blanket is both efficient and attractive.

The decorative strip may have ends overlapped by adjacent portions of the border strip. The decorative strip may also have a width greater than a width of the border strip. For example, the decorative strip may have a width in a range of about one-half to two inches.

In some embodiments, the decorative strip may extend linearly between opposing side edges of the textile base layer. In yet other embodiments, the decorative strip may extend in a V-shape between opposing side edges of the textile base layer. In other embodiments, the decorative strip may extend linearly between opposing end edges of the textile base layer. The decorative strip may extend diagonally between a side edge and an end edge of the textile base layer. The decorative strip may, of course, comprise a plurality of decorative strips for additional ornamentation. The closure strap may comprise a pair of closure straps. The water absorbent blanket may comprise polyvinyl alcohol fibers, for example.

The decorative cooling blanket may further comprise a textile overlay layer covering at least a portion of the textile base layer. The textile overlay layer may comprise decorative indicia on an outer exposed surface thereof.

A method aspect of the invention is for making a canine decorative cooling blanket. The method may include providing a textile base layer having a generally rectangular shape with a cutout head end portion to accommodate a neck of the canine, a longitudinally extending medial portion that is draped across a back of the canine, and respective side portions that extend along sides of the canine. The textile base layer may comprise a water absorbent material for cooling the canine based upon water evaporation. The method may further include covering edges of the textile base layer with a border strip, providing at least one closure strap for removably securing the textile base layer on the canine, and connecting at least one decorative strip extending between different edges of the textile base layer to an outer surface of the textile base layer. The method may also include covering at least a portion of the textile base layer with a textile overlay layer.

An alternate method aspect of the invention is also for making a decorative cooling blanket for a canine. The method may include providing a textile base layer having a generally rectangular shape with a cutout head end portion to accommodate a neck of the canine, a longitudinally extending medial portion that is draped across a back of the canine, and respective side portions that extend along sides of the canine. The textile base layer may comprise a water absorbent material for cooling the canine based upon water evaporation. The method may further include providing at least one closure strap for removably securing the textile base layer on the canine, and connecting at least one decorative strip extending between different edges of the textile base layer to an outer surface of the textile base layer. The method further includes covering at least a portion of the textile base layer with a textile overlay layer.

### BRIEF DESCRIPTION OF THE DRAWINGS

FIG. 1 is a side elevational view of a decorative cooling blanket on a canine in accordance with to the invention.

FIG. 2 is an enlarged side elevational view of a portion of the blanket shown in FIG. 1 and illustrating the decorative strip thereof.

FIG. 3 is an enlarged cross-sectional view of the intersection of the border strip of the decorative cooling blanket of FIG. 1.

FIG. 4 is a top plan view of an alternate embodiment of the decorative cooling blanket according to the invention.

FIG. 5 is a top plan view of another alternate embodiment of the decorative cooling blanket according to the invention.

FIG. 6 is a top plan view of a portion of another alternate embodiment of the decorative cooling blanket according to the invention.

FIG. 7 is an enlarged cross-sectional view of the intersection of a border strip of the decorative cooling blanket as shown in FIG. 6.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

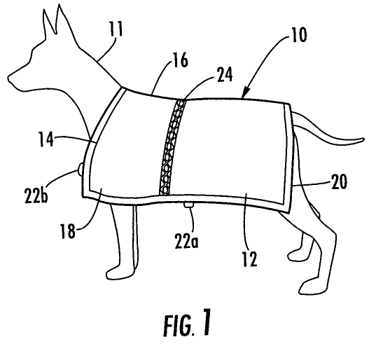

Referring initially to FIGS. 1-3, the decorative cooling blanket 10 for a canine in accordance with the invention is now described. The decorative cooling blanket 10 includes a textile base layer 12 having a generally rectangular shape with a cutout head end portion 14 to accommodate the neck of the canine 11. The textile base layer 12 may further include a longitudinally extending medial portion 16, which is draped across the back of the canine 11 and respective side portions 18 that extend along the sides of the canine.

The textile base layer 12 of the decorative cooling blanket 10 may comprise a water absorbent material, such as PVA fibers, for cooling the canine 11 based upon water evaporation. A border strip 20 illustratively covers the edges of the textile base layer 12. A lower closure strap 22a and a head end closure strap 22b may be connected to the textile base layer 12 to removably secure the textile base layer onto the canine 11.

A decorative strip 24 is connected to an outer surface of the textile base layer 12 and extends between different side edges thereof. Accordingly, the canine cooling blanket 10 is both efficient and attractive.

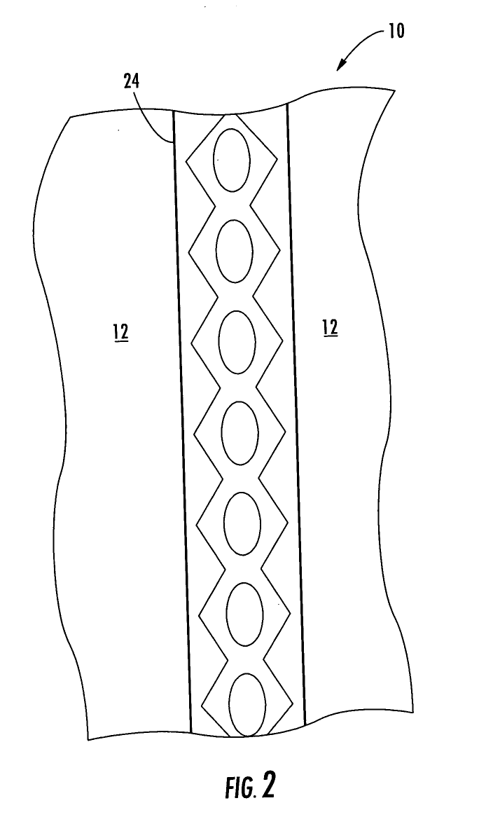

The decorative strip 24 may include decorative patterns, as shown perhaps best in FIG. 2, for example. The patterns may be of various colors, and/or textures, for example.

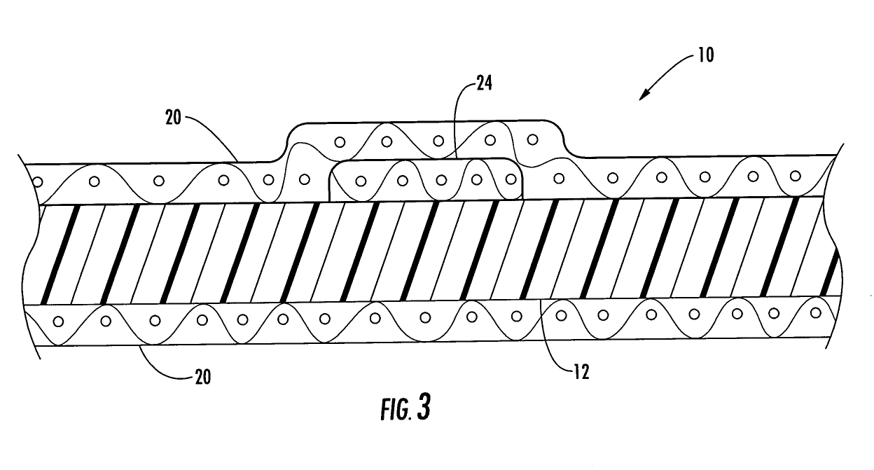

The decorative strip 24 may have ends overlapped by adjacent portions of the border strip 20 as is shown perhaps best in FIG. 3. The decorative strip 24 may have a width greater than a width of the border strip 20. The decorative strip 24 may have a width in a range of about one-half to two inches, for example.

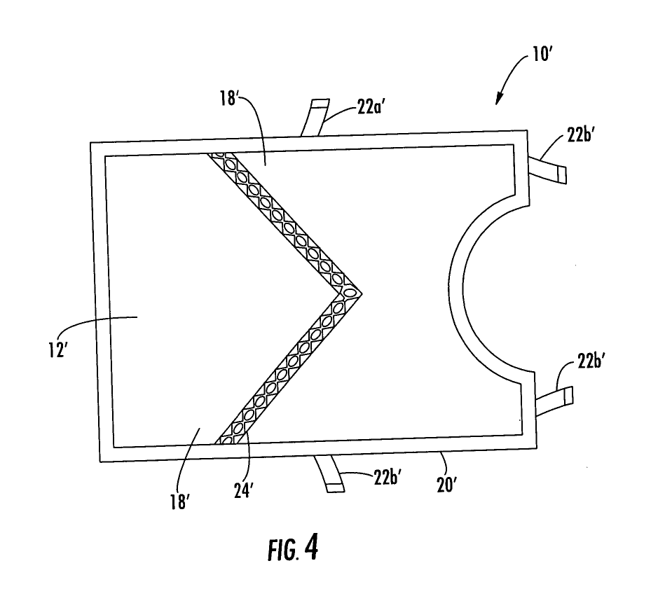

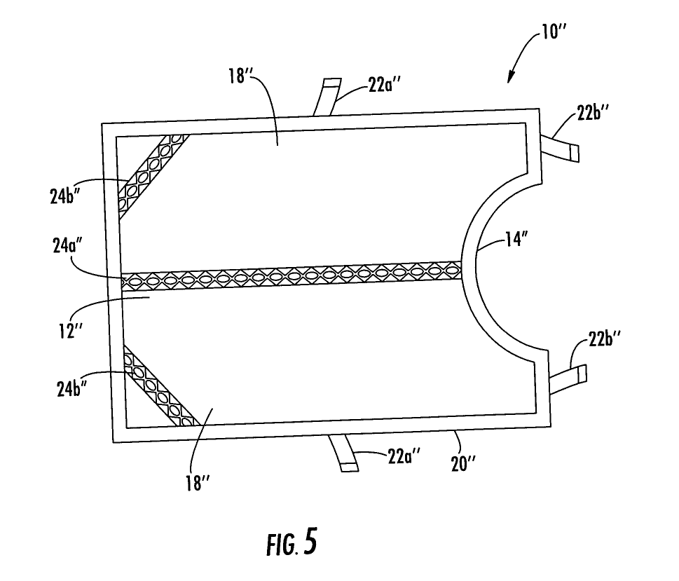

The decorative strip 24 may be positioned on the textile base layer 12 in any number of configurations. For example, the decorative strip 24 may extend linearly between opposing side edges of the textile base layer as in the embodiment shown in FIG. 1. In an alternate embodiment, the decorative strip 24′ may extend in a V-shape between opposing side edges of the textile base layer 12′ as is shown in FIG. 4. In yet another embodiment, one decorative strip 24a″ illustratively extends linearly between opposing end edges of the textile base layer 12″ as is illustrated in FIG. 5. Two other decorative strips 24b″ extend diagonally between a respective side edge 18 and an end edge of the textile base layer 12.

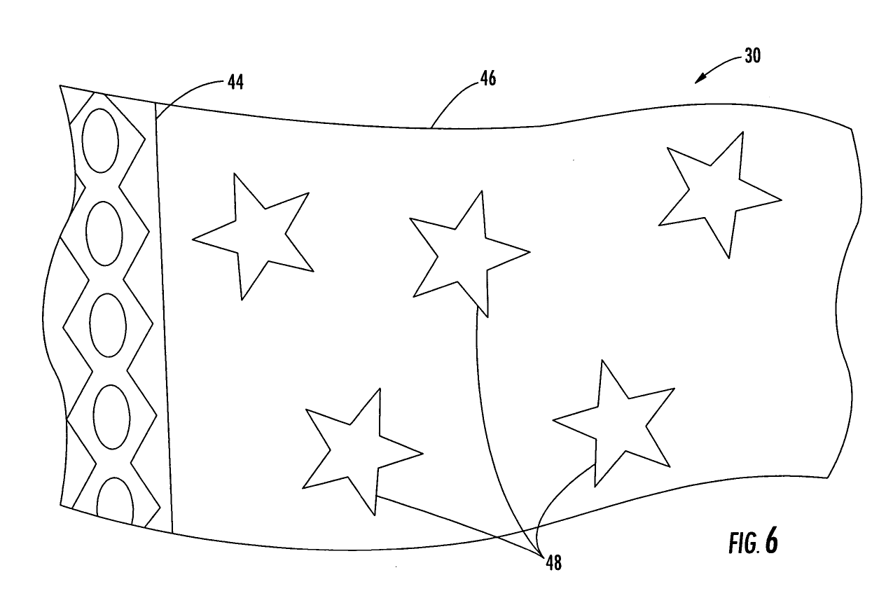

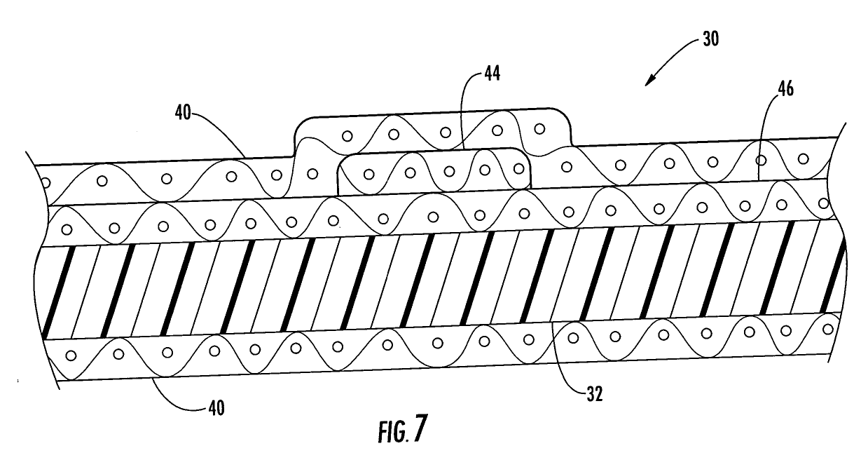

Referring now additionally to FIGS. 6 and 7 another embodiment of a decorative canine cooling blanket 30 is now described. In this embodiment, a textile overlay layer 46 covers the underlying textile base layer 32. The textile overlay layer 46 may comprise a cotton or cotton blend fabric, for example. The textile overlay layer 46 may provide additional cooling for the canine as will be appreciated by those skilled in the art. The textile overlay layer 46 may also include decorative indicia on an outer exposed surface thereof, such as the illustrated pattern of stars 48 as shown in FIG. 6. Other decorative indicia are also contemplated, such as may be provided by single or multiple colors, as well.

The textile overlay layer 46 may be used alone or in combination with the decorative strip 44 (FIG. 7) as described herein. The textile overlay layer 46 may be secured by an adhesive, and/or secured at its edges by a seam within the border strip 40 as seen in FIG. 7. Accordingly, the canine owner can provide further ornamentation for his show dog, for example.

Referring again to FIGS. 1-3, a method aspect of the invention is for making a canine decorative cooling blanket 10. The method may include providing a textile base layer 12 having a generally rectangular shape with a cutout head end portion 14 to accommodate the neck of the canine 11, a longitudinally extending medial portion 16 that is draped across the back of the canine, and respective side portions 18 that extend along the sides of the canine. The textile base layer may comprise a water absorbent material for cooling the canine based upon water evaporation. The method may further include covering edges of the textile base layer 12 with a border strip 20, connecting at least one closure strap 22a for removably securing the textile base layer on the canine 11, and connecting at least one decorative strip 24 extending between different edges of the textile base layer to an outer surface of the textile base layer. The method can also include covering at least a portion of the textile base layer 12 with a textile overlay layer 46 (FIGS. 6 and 7).

An alternate method aspect of the invention is also for making a decorative cooling blanket 30 for a canine as understood with additional reference to FIGS. 6 and 7. The method may include providing a textile base layer 32 having a generally rectangular shape with a cutout head end portion to accommodate a neck of the canine, a longitudinally extending medial portion that is draped across a back of the canine, and respective side portions that extend along sides of the canine. The textile base layer 32 may comprise a water absorbent material for cooling the canine based upon water evaporation. The method may further include providing at least one closure strap for removably securing the textile base layer 32 on the canine, and connecting at least one decorative strip 44 extending between different edges of the textile base layer to an outer surface of the textile base layer. The method further includes covering at least a portion of the textile base layer with a textile overlay layer 46.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A decorative cooling blanket for a canine comprising:
a textile base layer having a generally rectangular shape with a cutout head end portion to accommodate a neck of the canine while a longitudinally extending medial portion is draped across a back of the canine and respective side portions extend along sides of the canine, said textile base layer comprising a water absorbent material for cooling the canine based upon water evaporation;
a border strip covering edges of said textile base layer;
at least one closure strap connected to said textile base layer to removably secure said textile base layer on the canine; and
at least one decorative strip connected to an outer surface of said textile base layer and extending between different edges thereof.

2. The decorative cooling blanket according to claim 1 wherein said at least one decorative strip has ends overlapped by adjacent portions of said border strip.

3. The decorative cooling blanket according to claim 1 wherein said at least one decorative strip has a width greater than a width of said border strip.

4. The decorative cooling blanket according to claim 1 wherein said at least one decorative strip has a width in a range of about one-half to two inches.

5. The decorative cooling blanket according to claim 1 wherein said at least one decorative strip extends linearly between opposing side edges of said textile base layer.

6. The decorative cooling blanket according to claim 1 wherein said at least one decorative strip extends in a V-shape between opposing side edges of said textile base layer.

7. The decorative cooling blanket according to claim 1 wherein said at least one decorative strip extends linearly between opposing end edges of said textile base layer.

8. The decorative cooling blanket according to claim 1 wherein said at least one decorative strip extends diagonally between a side edge and an end edge of said textile base layer.

9. The decorative cooling blanket according to claim 1 wherein said at least one decorative strip comprises a plurality of decorative strips.

10. The decorative cooling blanket according to claim 1 wherein said at least one closure strap comprise a pair of closure straps.

11. The decorative cooling blanket according to claim 1 wherein said textile base layer comprises polyvinyl alcohol fibers.

12. The decorative cooling blanket according to claim 1 further comprising a textile overlay layer covering at least a portion of said textile base layer.

13. The decorative cooling blanket according to claim 12 wherein said textile overlay layer comprises decorative indicia on an outer exposed surface thereof.

14. A decorative cooling blanket for a canine comprising:
a textile base layer having a generally rectangular shape with a cutout head end portion to accommodate a neck of the canine while a longitudinally extending medial portion is draped across a back of the canine and respective side portions extend along sides of the canine, said textile base layer comprising a water absorbent material for cooling the canine based upon water evaporation;
a border strip covering edges of said textile base layer;
at least one closure strap connected to said textile base layer to removably secure said textile base layer on the canine; and
at least one decorative strip connected to an outer surface of said textile base layer and extending between opposing side edges thereof;
said at least one decorative strip having ends overlapped by adjacent portions of said border strip.

15. The decorative cooling blanket according to claim 14 wherein said at least one decorative strip has a width greater than a width of said border strip.

16. The decorative cooling blanket according to claim 14 wherein said at least one decorative strip extends linearly between opposing side edges.

17. The decorative cooling blanket according to claim 14 wherein said at least one decorative strip extends in a V-shape between opposing side edges of said textile base layer.

18. The decorative cooling blanket according to claim 14 further comprising a textile overlay layer covering at least a portion of said textile base layer.

19. A decorative cooling blanket for a canine comprising:
a textile base layer having a generally rectangular shape with a cutout head end portion to accommodate a neck of the canine while a longitudinally extending medial portion is draped across a back of the canine and respective side portions extend along sides of the canine, said textile base layer comprising a water absorbent material for cooling the canine based upon water evaporation;
at least one closure strap connected to said textile base layer to removably secure said textile base layer on the canine; and
a textile overlay layer covering at least a portion of said textile base layer.

20. The decorative cooling blanket according to claim 19 wherein said textile overlay layer comprises decorative indicia on an outer exposed surface thereof.

21. A method for making a decorative cooling blanket for a canine comprising:
providing a textile base layer having a generally rectangular shape with a cutout head end portion to accommodate a neck of the canine, a longitudinally extending medial portion to be draped across a back of the canine, and respective side portions to extend along sides of the canine, the textile base layer comprising a water absorbent material for cooling the canine based upon water evaporation;
covering edges of the textile base layer with a border strip;
connecting at least one closure strap to the textile base layer for removably securing the textile base layer on the canine; and
connecting at least one decorative strip to an outer surface of the textile base layer extending between different edges of the textile base layer.

22. The method according to claim 21 further comprising covering at least a portion of the textile base layer with a textile overlay layer.

23. The method according to claim 21 wherein the at least one decorative strip has ends overlapped by adjacent portions of the border strip.

24. The method according to claim 21 wherein the at least one decorative strip has a width greater than a width of the border strip.

25. A method for making a decorative cooling blanket for a canine comprising:
providing a textile base layer having a generally rectangular shape with a cutout head end portion to accommodate a neck of the canine, a longitudinally extending medial portion to be draped across a back of the canine, and respective side portions to extend along sides of the canine, the textile base layer comprising a water absorbent material for cooling the canine based upon water evaporation;
connecting at least one closure strap to the textile base layer for removably securing the textile base layer on the canine; and
covering at least a portion of the textile base layer with a textile overlay layer.

26. The method according to claim 25 wherein the textile overlay layer comprises decorative indicia on an outer exposed surface thereof.
